(19) United States
(12) Patent Application Publication
(10) Pub. No.: US 2023/0267450 A1
(43) Pub. Date: Aug. 24, 2023

(54) FRACTIONAL NON-FUNGIBLE TOKEN TRADING MARKETPLACE

(71) Applicant: INTERNATIONAL BUSINESS MACHINES CORPORATION, ARMONK, NY (US)

(72) Inventors: Luis Angel Bathen, Placentia, CA (US); Akil Khamisi Sutton, Poughkeepsie, NY (US); Marc Henri Coq, Hopewell Junction, NY (US); CEDRIC D. COOK, Richmond, TX (US)

(21) Appl. No.: 17/652,107

(22) Filed: Feb. 23, 2022

(51) Int. Cl. G06Q 20/36; G06Q 20/38; G06Q 20/40

(52) U.S. Cl. CPC G06Q 20/3672; G06Q 20/3678; G06Q 20/389; G06Q 20/401

(57) ABSTRACT

According to one embodiment, a method, computer system, and computer program product for fractional NFT trading marketplace is provided. The embodiment may include minting a mark associated with an entity as a fractional non-fungible token by a creator with ownership or authority over the mark, where the creator establishes a plurality of parameters during the minting. The embodiment may also include processing one or more purchases of one or more fractions of the fractional non-fungible token by one or more individuals from the creator. The embodiment may further include monitoring data associated with the fractional non-fungible token for criteria that triggers an event. The embodiment may also include in response to the criteria being present, executing the event.

### BACKGROUND

The present invention relates generally to the field of computing, and more particularly to the non-fungible tokens (NFTs).

NFTs are unique digital assets sold and purchasable in an online marketplace. Typically, NFTs represent the digitized form of a real-life entity, such as artwork, music, images, and videos, but may have seemingly boundless uses. NFTs are accompanied by unique identification codes that are linked to a blockchain, which results in the non-fungibility of the digital asset. Since only a single entity with the specific identification code exists on the blockchain, scarcity is created and, thus, supply of the digital asset is limited. Generally, NFTs are available for purchase on a marketplace with fungible assets, such as cryptocurrencies. For example, an NFT representing a painting may be bid upon on a digital auction website with the Ethereum blockchain cryptocurrency Ether.

### SUMMARY

According to one embodiment, a method, computer system, and computer program product for fractional NFT trading marketplace is provided. The embodiment may include minting a mark associated with an entity as a fractional non-fungible token by a creator with ownership or authority over the mark, creator the user establishes a plurality of parameters during the minting. The embodiment may also include processing one or more purchases of one or more fractions of the fractional non-fungible token by one or more individuals from the creator. The embodiment may further include monitoring data associated with the fractional non-fungible token for criteria that triggers an event. The embodiment may also include in response to the criteria being present, executing the event.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for an NFT ownership process according to at least one embodiment.

FIG. 3 illustrates an operational flowchart of a takeover event under the NFT ownership process according to at least one embodiment.

FIG. 4 illustrates an operation flowchart of a fraction splitting event under the NFT ownership process according to at least one embodiment.

FIG. 5 illustrates a block diagram of a network participants involved in an NFT ownership process according to at least one embodiment.

FIG. 6 illustrates a block diagram of an end-to-end listing process by an NFT ownership process according to at least one embodiment.

FIG. 7 is a block diagram of internal and external components of computers and servers depicted in FIG. 1 according to at least one embodiment.

FIG. 8 depicts a cloud computing environment according to an embodiment of the present invention.

FIG. 9 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to the non-fungible tokens (NFTs). The following described exemplary embodiments provide a system, method, and program product to, among other things, list organizations as fractional NFTs in a marketplace. Therefore, the present embodiment has the capacity to improve the technical field of NFTs by expanding revenue driving opportunities for organizations beyond traditional means presented by an initial public offering in a stock exchange.

As previously described, NFTs are unique digital assets sold and purchasable in an online marketplace. Typically, NFTs represent the digitized form of a real-life entity, such as artwork, music, images, and videos, but may have seemingly boundless uses. NFTs are accompanied by unique identification codes that are linked to a blockchain, which results in the non-fungibility of the digital asset. Since only a single entity with the specific identification code exists on the blockchain, scarcity is created and, thus, supply of the digital asset is limited. Generally, NFTs are available for purchase on a marketplace with fungible assets, such as cryptocurrencies. For example, an NFT representing a painting may be bid upon on a digital auction website with the Ethereum blockchain cryptocurrency Ether.

The process of creating an NFT begins by creating a digital representation of an asset. For example, an image, a video, or a graphic interchange format (GIF) are currently typical NFT digital representations. This digital representation operates through an algorithm that hashes and creates a unique repeatable representation of the asset.

When beginning the NFT creation process, a user may log into a digital marketplace, such as OpenSea® (OpenSea and all OpenSea-based trademarks and logos are trademarks or registered trademarks of Ozone Networks, Inc. and/or its affiliates), generate a template for the NFT, and then proceed to minting the NFT. The NFT minting process typically requires the creator to pay fees in order to run on the blockchain. For example, if the NFT is to be minted on the Ethereum blockchain, the NFT creator may be required to pay gas fees in the form of the Ethereum cryptocurrency Ether. The NFT creation process may vary based on the platform being used for minting, however, a unique representation of the NFT is ingested into a blockchain for future reference.

Once an NFT is generated, creators may then place the NFT up for sale on the chosen marketplace and receive community bids to purchase the posted NFT similar to online auction websites. The NFT may be bought and sold on the marketplace and its digital representation is saved on the same blockchain on which it is traded. A vital aspect of the NFT exchange process is that the NFT is codified and rules/policies pertaining to how the NFT is traded are set by the creator. For example, a creator, or author, of an NFT may set a rule that dictates, each time the NFT changes hands, a percentage of the purchase price is transferred to the original author, similar to a royalty. This allows for revenue generation for the original creator of the NFT beyond the initial sale of the asset.

Recently, some marketplaces have allowed digital assets, such as NFTs, to be split or separated into n-fractions or shards, which are then sold separately on the marketplace. The fractional NFTs (f-NFTs) allow users to own a piece of an NFT and trade them on the marketplace. Such technology enables the treatment of an NFT as a financial asset, slightly similar to a cryptocurrency, where the value of the fraction goes up or down depending on demand.

In a sense, NFT marketplaces present similarities to public stock exchanges where companies are publicly held by shareholders in the form of stock issued by the company. However, many organizations or entities, such as small businesses, real estate owners, and owners of tangible goods, wishing to raise capital may either not fit the criteria to be listed on a public stock exchange or prefer to remain privately held.

Similarly, listing on a public stock exchange may be costly for an entity seeking to raise capital. An initial public offering (IPO) or a direct listing present gateways for businesses to enter a marketplace and raise funds from eager investors. The IPO and listing processes may be very involved and include high fees making entry a difficult process for small business owners. For example, the National Association of Securities Dealers Automated Quotations (NASDAQ) stock market requires, at a minimum, $150,000 in fees and other application criteria before an IPO is approved for the issuance of share of stock. Many small businesses may seek smaller amounts of funding that the application fee to be listed on a public exchange, such as the NASDAQ, however, such business may have no means to be able to secure such an injection of cash. As such, it may be advantageous to, among other things, utilize f-NFTs and an NFT marketplace to allow organizations an opportunity to trade assets and raise capital that would otherwise be unavailable.

According to at least one embodiment, NFTs and f-NFTs may be treated as listed stocks on an exchange. For example, an image, such as a logo representing an organization, a piece of real estate or a tangible item, may be minted as an NFT or f-NFT by the user and listed on an exchange or marketplace for purchase or trade by users. The entity (e.g., an individual or an organization) minting the NFT may dictate certain parameters through a smart contract surrounding the NFT, such as number of fractions created during minting, initial price offering for each fraction or the NFT as a whole, takeover event rules, and share/fraction splitting rules, established during the minting process. Natural economic measures may then dictate the price movement of the circulating NFT or NFT fractions. In at least one embodiment, upon the occurrence of certain trigger events, the NFT parameters may be dynamically reprogrammed. Currently, once an NFT is minted, the characteristics of the NFT are final and may not be altered even after a change in ownership. However, dynamic reprogramming upon certain trigger events may allow for an environment more conducive to NFT or f-NFT owners when NFTs or fractions change hands.

In at least one other embodiment, a takeover event may be initiated by an entity (e.g., a user or organization) that wishes to purchase all circulating fractions of the NFT or f-NFT. In such an event, the bidder for the NFT or f-NFT may deposit a down payment in an escrow account equivalent to a predetermined figure. Subsequent to the down payment, each owner of the NFT or f-NFT may stake their fractions and place a vote on whether to sell the NFT or f-NFT to the bidder or reject the bid and keep possession of the NFT or f-NFT. The voting rules may be predetermined based on the parameters established when the NFT or f-NFT was minted. For example, the creator of the NFT or f-NFT may determine that each owner receives one vote regardless of the number of fractions held. Similarly, each owner may receive one vote for each fraction held. In the event the takeover event receives approval, the NFT is transferred to the purchaser and the down payment is distributed to each seller proportional to the parameters established upon minting. Upon transfer to the new owner(s), all existing fractions may be burned, or sent to a burn address, and a new NFT may be created that is fully owned by the purchaser. The new purchaser may then generate new fractions and place the NFT or f-NFT back on the marketplace if desired. In at least one further embodiment, the purchase may be a single individual or a community that has pooled funds and placed those funds in an escrow account.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to utilize NFT or f-NFT trading by organizations as an alternative to a stock exchange listing.

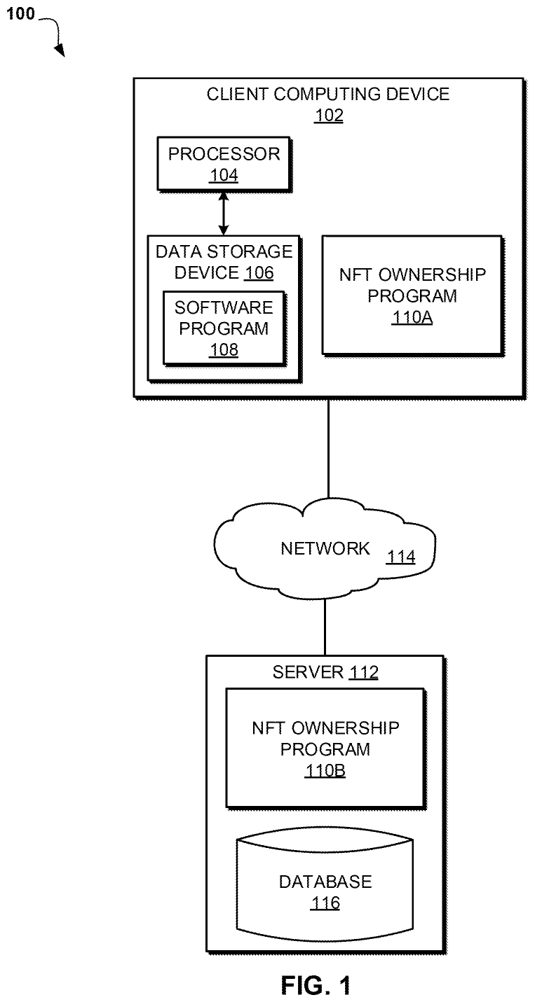

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity. Additionally, in one or more embodiments, the client computing device 102 and server 112 may each individually host an NFT ownership program 110A, 110B. In one or more other embodiments, the NFT ownership program 110A, 110B may be partially hosted on both the client computing device 102 and the server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

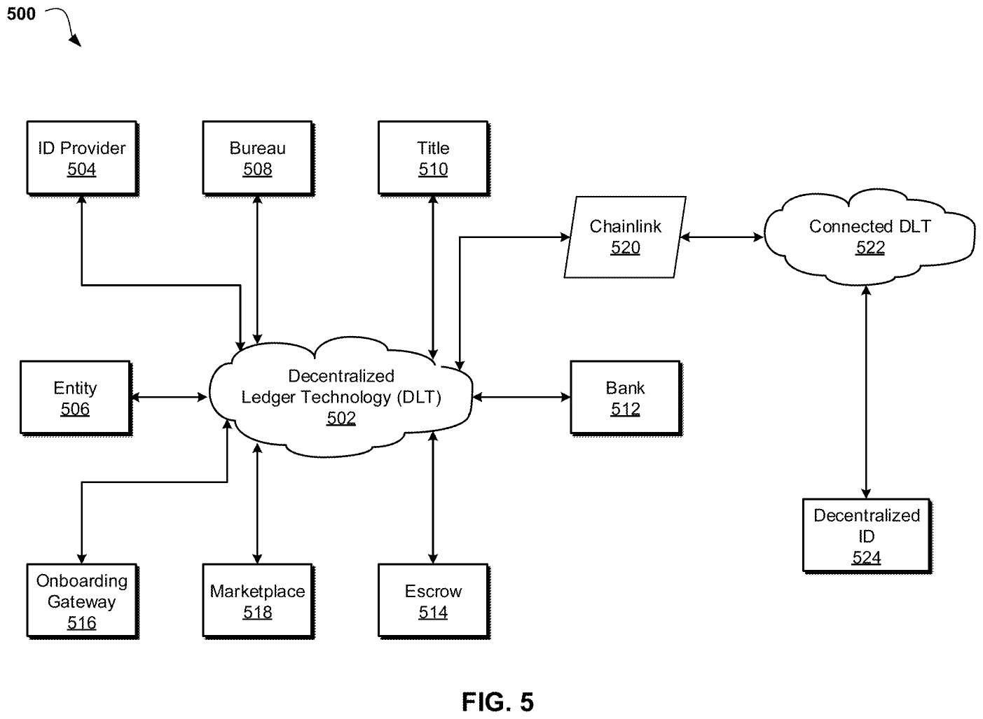

Client computing device 102 may include a processor 104 and a data storage device 106 that is enabled to host and run a software program 108 and an NFT ownership program 110A and communicate with the server 112 via the communication network 114, in accordance with one embodiment of the invention. In one or more other embodiments, client computing device 102 may be, for example, a mobile device, a telephone, a personal digital assistant, a netbook, a laptop computer, a tablet computer, a desktop computer, or any type of computing device capable of running a program and accessing a network. As previously described, one client computing device 102 is depicted in FIG. 1 for illustrative purposes, however, any number of client computing devices 102 may be utilized. As will be discussed with reference to FIG. 5, the client computing device 102 may include internal components 502a and external components 504a, respectively.

The server computer 112 may be a laptop computer, netbook computer, personal computer (PC), a desktop computer, or any programmable electronic device or any network of programmable electronic devices capable of hosting and running an NFT ownership program 110B and a database 116 and communicating with the client computing device 102 via the communication network 114, in accordance with embodiments of the invention. As will be discussed with reference to FIG. 5, the server computer 112 may include internal components 502b and external components 504b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

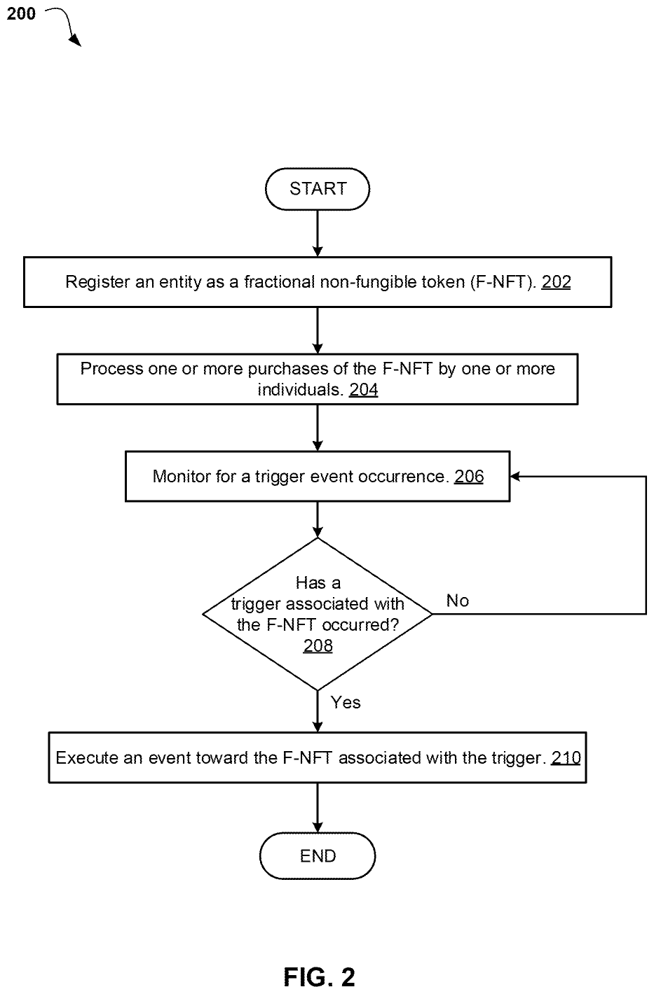

According to the present embodiment, the NFT ownership program 110A, 110B may be an exchange for minting and trading NFTs and f-NFTs that represent shares of organizations, such as businesses, charities, institutions, or associations. The NFTs and f-NFTs may be minted by a creator user on the trading marketplace program 110A, 110B before being listed for trading. In at least one embodiment, the creator user may possess ownership, or authority to mint an NFT, of the organization. For example, the creator user may be the owner of a small book retail store. Additionally, at the time of creation, the creator user may establish parameters associated with the NFT, such as initial price offering, number of fractions available for sale, fees paid to the creator user upon subsequent sales, takeover event criteria, fraction splitting criteria, and reverse fraction splitting criteria. The organization NFT method is explained in further detail below with respect to FIGS. 2-4.

Referring now to FIG. 2, an operational flowchart illustrating an NFT ownership process 200 is depicted according to at least one embodiment. At 202, the NFT ownership program 110A, 110B registers an entity as an f-NFT. Registering an entity as an f-NFT may refer to the process of minting and listing an f-NFT, or fractions of an NFT, for sale or auction on a marketplace by the NFT ownership program 110A, 110B. As previously described, the entity may be a logo associated with an organization, a piece of real estate, or a tangible item. When a user wishes to generate, or mint, an f-NFT of an organization, the user may perform necessary steps of registration with an NFT marketplace, such as OpenSea®. Since the NFT ownership program 110A, 110B utilizes NFTs and f-NFTs that represent organizations, entities, or items, during the registration process, the creator user may be required to provide verification that the user is the owner of, or otherwise authorized to generate an f-NFT on behalf of, the organization, entity, or item. For example, if a user owns a local bake shop and wishes to create an f-NFT of the shop's logo to allow patrons or investors to purchase an interest in the bake shop, the user may be required to submit verification that the user owns the business and, therefore, has authority to mint the f-NFT. Prior to posting fractions of the generated f-NFT for sale or auction, the creator user may be required to pay one or more fees associated with the creating and listing the f-NFT for sale, such as, but not limited to, a minting transaction fee, a marketplace listing fee, a creator fee, a royalty fee, a smart contract approval fee, and a blockchain gas fee. In at least one embodiment, the one or more fees may be paid for each fraction to be listed on the marketplace.

During the registration process, the user may establish one or more parameters that affect the NFT, such as number of fractions created during minting, initial price offering for each fraction, initial price offering for the NFT as a whole, a takeover event trigger, takeover event rules, a shore/fraction splitting trigger, and share/fraction splitting rules. The one or more parameters may be stored in a repository, such as database 118, or on the blockchain that stores the f-NFT in the form of a smart contract.

In at least one embodiment, the NFT ownership program 110A, 110B may be deployed on any blockchain that supports NFT exchange, such as the Ethereum, Cardano, or Solana blockchains. In another embodiment, the NFT ownership program 110A, 110B may be utilized cross chain or allow for a bridge between blockchains. Similarly, since the NFT ownership program 110A, 110B may be deployed and utilized on any blockchain that support NFT exchange, the NFT ownership program 110A, 110B may also allow any cryptocurrency supported by the corresponding blockchain to be used for purchasing the generated NFT or f-NFT. For example, if the NFT ownership program 110A, 110B is deployed on the Ethereum blockchain, any ERC-20 fungible cryptocurrency token, such as Ether, Chainlink, Loopring, and Polygon, may be used to submit sales offers or place auction bids for the f-NFT.

Then, at 204, the NFT ownership program 110A, 110B processes one or more purchases of the f-NFT by one or more individuals. After the f-NFT is listed for sale, the NFT ownership program 110A, 110B may receive offers for purchase or bids by individuals wishing to own the listed f-NFT depending on whether the f-NFT is posted as a sale or an auction. The NFT ownership program 110A, 110B may receive offers for purchase or bids for each individual fraction of the f-NFT that is listed. The NFT ownership program 110A, 110B may continue listing the f-NFT until all listed fractions have been purchased or the listing is removed by the creator user.

Once a purchase is made or a bid is accepted, the NFT ownership program 110A, 110B may complete the transaction for a fraction of the f-NFT. In completing the transaction, the NFT ownership program 110A, 110B may transfer ownership of the purchased fraction of the f-NFT to the purchasing user and transfer custody of the purchasing funds to the creator, or seller, user. In at least one embodiment, transactional fees, such as marketplace fees, blockchain gas fees, and royalty fees, may also be transferred to the appropriate entities during the transfer of funds from the purchasing user to the seller user.

Next, at 206, the NFT ownership program 110A, 110B monitors the NFT marketplace for a trigger event occurrence. As previously described, the creator user may establish parameters at the time of minting the f-NFT, which may include trigger event criteria for events, such as takeover events and fraction splitting events. The NFT ownership program 110A, 110B may monitor each fraction of the f-NFT for the occurrence of such triggers. For example, the creator user may establish, upon minting, that a takeover event is triggered when a buyer places a purchase bid that is 5% or higher than the asking price for all fractions of the f-NFT.

Then, at 208, the NFT ownership program 110A, 110B determines whether a trigger associated with the f-NFT has occurred. The NFT ownership program 110A, 110B may determine an event should be executed toward the f-NFT when the monitoring in step 206 identifies the occurrence of a trigger, such as a bid to purchase all fractions of the f-NFT that satisfies a preconfigured price ceiling or when the asking price for f-NFT fractions exceeds a preconfigured value. If the NFT ownership program 110A, 110B determines that a trigger event associated with the NFT has occurred (step 208, “Yes” branch), the NFT ownership method 200 may proceed to step 210 to execute an event toward the f-NFT associated with the trigger. If the NFT ownership program 110A, 110B determines a trigger associated with the f-NFT has not occurred (step 208, “No” branch), the NFT ownership method 200 may return to step 206 to continue monitoring for a trigger event occurrence.

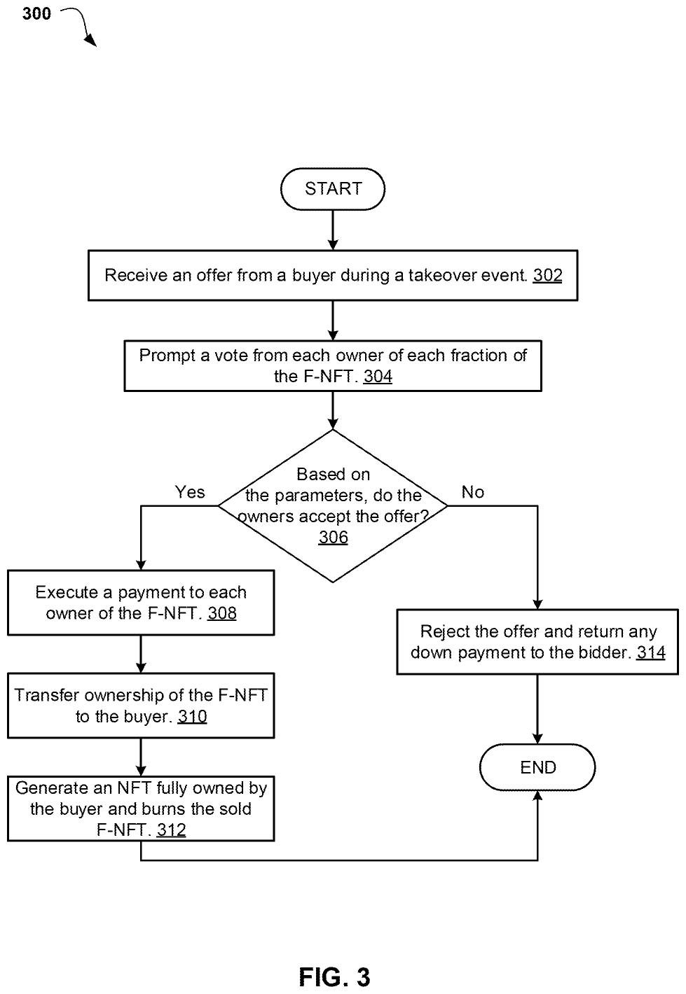

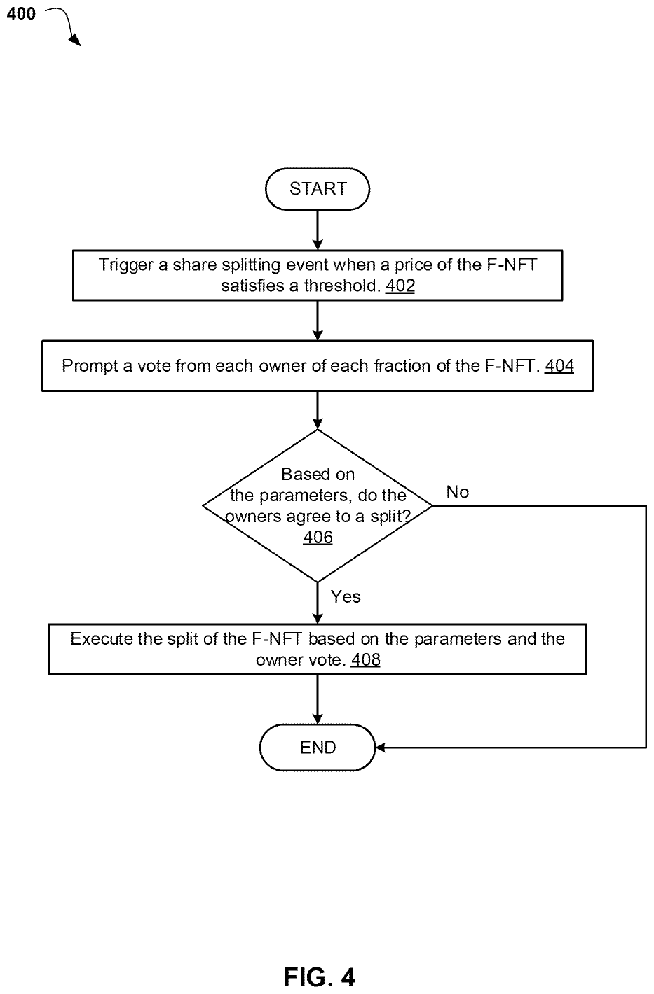

Next, at 210, the NFT ownership program 110A, 110B executes the event associated with the f-NFT. As previously described, the event to be executed toward the f-NFT corresponds to the trigger determined in step 208. For example, if a bid to purchase all fractions of the f-NFT at a price greater than a preconfigured asking price is received, the NFT ownership program 110A, 110B may determine that a takeover event is to be executed. Similarly, if the sum of the asking price for all fractions exceeds a preconfigured value, the NFT ownership program 110A, 110B may determine a fraction splitting event should be initiated and taken to a vote of the owners of the f-NFT fractions. The takeover event is described in more detail in FIG. 3 and the fraction splitting event is described in more detail in FIG. 4.

Referring now to FIG. 3, an operational flowchart illustrating a takeover event method 300 under the NFT ownership process is depicted according to at least one embodiment. At 302, the NFT ownership program 110A, 110B receives an offer from an offeree (e.g., a potential buyer or buyer) during a takeover event. As previously described, a takeover event may relate to a buyer's attempt to acquire all fractions of the f-NFT from the current holder(s). The NFT ownership program 110A, 110B may monitor trading activity on the NFT marketplace on which the f-NFT resides to determine when actions occur that trigger the takeover event. For example, the NFT ownership program 110A, 110B may identify that a takeover event is being attempted when a bid to purchase all fractions of the f-NFT is placed a preconfigured percentage above the current asking price for a given fraction or an average asking price of all fractions. In at least one embodiment, the bidder attempting to purchase the f-NFT outright may be required to place a down payment or bid amount in part or in full in an escrow account pending the outcome of a proposal vote by the current owners of the f-NFT fractions. The down payment may be based on market price of the f-NFT or the individual fractions and volatility of the fraction price or price of the f-NFT as a whole.

Then, at 304, the NFT ownership program 110A, 110B prompts a vote from the owner of, or any individual with an interest in, each fraction of the f-NFT. Upon receiving a purchase bid that satisfies the takeover event trigger criteria, the NFT ownership program 110A, 110B may initiate a voting period for each of the fraction owners to accept or reject the takeover proposal. The NFT ownership program 110A, 110B may present the vote to the current owners and allow each owner to vote as to whether the bid should be accepted, rejected, or countered. Based on the parameters established by the creator owner, the NFT ownership program 110A, 110B may open the vote to the owners for a preconfigured period of time. Furthermore, the NFT ownership program 110A, 110B may send a notification to each owner to vote once the voting window has begun. The NFT ownership program 110A, 110B may host and keep a count of the vote either internally or work as an interface with an NFT marketplace that is enabled to host and keep count of the vote.

Next, at 306, the NFT ownership program 110A, 110B determines, based on a policy, whether the owner(s) of the f-NFT agree to accept the offer. Similar to the criteria that triggers the takeover event, the criteria that determine whether the owners of the f-NFT fractions accept the takeover event may be established by the creator owner upon minting the f-NFT. For example, the parameters established by the creator user may require 100% of the owners of the fractions to agree to the takeover event. Similarly, the parameters may require a quorum, a majority, or a super majority of the owners to agree to the takeover event. In at least one embodiment, the NFT ownership program 110A, 110B may allow users that do not agree to the takeover event to opt out of the sale and transfer to the bidder, thus allowing the bidder to take ownership of all fractions of only the users that agreed to the takeover event.

Once the voting period has concluded, the NFT ownership program 110A, 110B may tally the final voting figures and compare the totals and ratios for each available voting choice to determine if the owners have accepted, rejected, or countered the bidder's offer under the parameters. If the NFT ownership program 110A, 110B determines that the owners accepted the offer (step 306, “Yes” branch), the takeover event method 300 may proceed to step 308 to execute a payment to each owner of the f-NFT. If the NFT ownership program 110A, 110B determines the owners did not accept the offer (step 306, “No” branch), the takeover event method 300 may proceed to step 314 to reject the offer and return any down payment to the bidder.

Then, at 308, if the offer is accepted, the NFT ownership program 110A, 110B executes a payment to each owner of the f-NFT. The payment transferred to each fraction owner may be based on the parameters established by the creator user or as voted upon by the owners. For example, the amount transferred to each owner may be equivalent to the total payment made by the purchaser over the total number of fractions. Therefore, each owner may receive an equal distribution of the payment value. In at least one other embodiment, the owner of each fraction may receive a portion of the total payment price equivalent to the value of their owned fraction. For example, if an f-NFT has 10 fractions where nine fractions are valued at 50% of the cumulative NFT value and one fraction is valued at the remaining 50% of the cumulative NFT value, the owner of the fraction possessing 50% of the cumulative NFT value may receive 50% of the payment value from the purchaser and the owners of the other nine fractions may receive a division of the remaining 50% of the payment value.

Next, at 310, the NFT ownership program 110A, 110B transfers ownership of the f-NFT to the buyer. Once the purchaser's down payment has been transferred to each of the owners/sellers, the NFT ownership program 110A, 110B may transfer ownership of all fractions to the purchaser and the purchase may assume full ownership of the complete NFT. If under the parameters previously described, the purchaser takes possession of less that all fractions due to only the fractions of owners accepting the purchase being transferred, the NFT ownership program 110A, 110B may only transfer the fractions owned by the accepting owners.

Then, at 312, the NFT ownership program 110A, 110B generates an NFT fully owned by the buyer and burns each fraction of the sold f-NFT. If the purchaser acquires all fractions of the f-NFT, the NFT ownership program 110A, 110B may generate a new fraction-less NFT that is wholly owned by the purchaser. The NFT ownership program 110A, 110B may establish the value of the new NFT as the cumulative value of all fractions purchased in the takeover event. Once the new NFT is generated, the NFT ownership program 110A, 110B may burn all existing fractions so that the purchaser now has ownership over a complete NFT. In an embodiment where only a portion of the fractions of the f-NFT are transferred to the purchaser, the NFT ownership program 110A, 110B may effectively merge the fractions by generating an NFT equivalent to the number of fractions purchased and burn the previously unmerged fractions.

In at least one embodiment, the purchaser/new owner of the generated NFT may reprogram or modify the parameters of the NFT due to the NFT now being privately owned by the purchaser/new owner. If desired, the NFT may be relisted for sale or trade or held privately. For example, if the new owner purchases 1,000 fractions of an f-NFT for $10 per fraction and the parameters are updated to establish 10,000 fractions, the new owner may instruct the NFT ownership program 110A, 110B to relist the NFT as an f-NFT for $1 per fraction for each of the 10,000 fractions.

Next, at 314, if the offer is rejected, the NFT ownership program 110A, 110B rejects the offer and returns any proffered down payment. When the owner(s) of each fraction reject the bidder's offer under the parameters established by the creator user, the NFT ownership program 110A, 110B may notify the bidder and return any down payment submitted in escrow to the account from which it was transacted.

Referring now to FIG. 4, an operation flowchart illustrating a fraction splitting event method 400 under the NFT ownership process is depicted according to at least one embodiment. At 404, the NFT ownership program 110A, 110B triggers a fraction splitting event when preconfigured criteria associated with the F-NFT are satisfied. A fraction splitting event may be defined as an event that splits the existing fractions of an NFT into a new larger number of fractions. Typically, the fraction splitting event splits the existing fractions into even multiples, such as 2-for-1 fraction splits, however, any number of splits may result from a fraction splitting event, such as 3-for-2 fraction splits. The criteria for the fraction splitting event may include a price of one or more fractions of the f-NFT satisfying a preconfigured threshold. The preconfigured threshold may be established by the user creator in the parameters established when minting the f-NFT or by a subsequent purchaser that may have modified the parameters. For example, the parameters may establish the criteria that triggers a fraction split may be the price of a single fraction of the f-NFT being sold above a preconfigured threshold value. Similarly, the parameters may establish the criteria for the fraction splitting event trigger to be the average price of all fractions of the f-NFT or a cumulative price of all fractions of the f-NFT satisfying a threshold value.

Then, at 404, the NFT ownership program 110A, 110B prompts a vote from each owner of, or each individual with an interest in, each fraction of the F-NFT. Similar to the vote conducted in step 304, the NFT ownership program 110A, 110B may initiate a voting period for each of the fraction owners to accept or reject the fraction splitting proposal upon the satisfaction of the trigger event. The NFT ownership program 110A, 110B may present the vote to the current owners and allow each owner to vote as to whether the fraction split should occur and the characteristics of the fraction split. Based on the parameters established by the creator owner, the NFT ownership program 110A, 110B may open the vote to the owners for a preconfigured period of time. Furthermore, the NFT ownership program 110A, 110B may send a notification to each owner to vote once the voting window has begun. The NFT ownership program 110A, 110B may host and keep a count of the vote either internally or work as an interface with an NFT marketplace that is enabled to host and keep count of the vote.

Next, at 406, the NFT ownership program 110A, 110B determines, based on the parameters, whether the owner(s) of each fraction agree to a split of the F-NFT. Similar to the determination made in step 306, the NFT ownership program 110A, 110B may make a determination on whether the owners of each fraction agree to a fraction split based on the parameters. As was previously described, the percentage of owners agreeing to the fraction split may be based on the established parameters. Once the voting period has concluded, the NFT ownership program 110A, 110B may tally the final voting figures and compare the totals and ratios for each available voting choice to determine if the owners agree to the fraction split. If the NFT ownership program 110A, 110B determines that the owners agree to the fraction split (step 406, “Yes” branch), the fraction splitting event method 400 may proceed to step 408 to execute the fraction split of the f-NFT based on the parameters and the owner vote. If the NFT ownership program 110A, 110B determines the owners did not agree to a fraction split (step 406, “No” branch), the fraction splitting event method 400 may terminate.

Then, at 408, if the owner(s) of each fraction agree to a split, the NFT ownership program 110A, 110B execute a splitting of the F-NFT based on the parameters and the owner vote. Should the owners agree to the fraction split under the parameters, the NFT ownership program 110A, 110B may begin a fraction split under the parameters or as voted upon by the owner. For example, if the parameters may establish that only 2-for-1 fraction splits are permissible and, therefore, in the event the owners vote to split the fractions, the NFT ownership program 110A, 110B may execute a 2-for-1 fraction split. Similarly, if the owners vote for a 3-for-1 fraction split and the parameters allow for such a split or are silent as to the allowable fraction divisions, the NFT ownership program 110A, 110B may initiate a 3-for-1 fraction split.

When executing a fraction split, the NFT ownership program 110A, 110B may generate new fractions based on the existing fractions and mint the new fractions accordingly under the NFT marketplace rules. For example, if the NFT marketplace requires payment specific fees when minting new NFTs, the NFT ownership program 110A, 110B may require each owner to pay the applicable fees to generate the new fractions.

The NFT ownership program 110A, 110B may value of the fractions generated during the fraction split as a percentage of the original fraction value based on the fraction split value. For example, if one fraction of an f-NFT is owned by an owner and is valued at $1,000 prior to a 2-for-1 split, then, after the split, two fractions may be owned by the owner each valued at $500. Therefore, the overall value of the fractions is retained throughout the split. However, the owner may then list the next fraction(s) for sale at a price of the owner's choosing.

In at least one embodiment, the NFT ownership program 110A, 110B may allow the owners that voted in favor of a fraction split to split their fractions while allowing the owners who did not split their fractions to keep their current ownership. For example, if Owner A voted for a 2-for-1 fraction split and Owner B voted against the 2-for-1 fraction split, the NFT ownership program 110A, 110B may allow Owner A to execute the agreed upon split while also allowing Owner B to keep the originally owned fractions without a split. This may result in the total number of fractions owner between Owner A and Owner be to rise from two fractions to three fractions.

FIG. 5 illustrates a block diagram of a network participants involved in an NFT ownership process according to at least one embodiment. The network participants of the NFT ownership program 110A, 110B may include ID provider 504, entity 506, bureau 508, title 510, bank 512, escrow 514, onboarding gateway 516, marketplace 518, and decentralized ID 524 each connected through decentralized ledger technology (DLT), such as DLT 502 and connected DLT 522. In at least one embodiment, DLT 502 and connected DLT 522 may represent different DLTs that are linked, by chainlink 520. A DLT, such as DLT 502 and connected DLT 522, may relate to a technological infrastructure and protocol that allow access, validation, and record modification immutably across a multi-entity network simultaneously.

With the network participants, ID provider 504 may relate to a service that provides the identity of individuals or entities in control of assets across a ledger. Decentralized identifiers may be leveraged, which may be local or provided through a global identity provider (e.g., a national or global ID program). A global identity provider may require a connection to an outside ledger. In at least one embodiment, each element depicted in FIG. 5 (i.e., elements 504-518 and 524) represent a service provider within the network. However, in at least one embodiment, an implementation may include any single node in the network, an oracle talking to an outside cloud service, or a separate ledger accessed via a chainlink, such as chainlink 520.

Of the other elements represented, entity 506 may represent a party that wishes to list an f-NFT on a marketplace, such as marketplace 518; bureau 508 may represent a service that verifies various aspects of entity 506; title 510 may represent a title company performing typical services provided by a title company; bank 512 may be utilized to provide needed proof-of-funds and deposits; escrow 514 may represent an escrow company that places a lien, collects initial deposits, and other services typical of an escrow company; onboarding gateway 516 may represent a service used to complete the onboarding process; and marketplace 518 may represent the service that hosts the generated f-NFT after minting and allows 24/7 trading. In at least one embodiment, bank 512 may be replaced by a decentralized authority that manages funds on the ledger, thus, making fund verification immediate as verification is managed by on-ledger. In at least one other embodiment, escrow 514 may also run within the ledger itself.

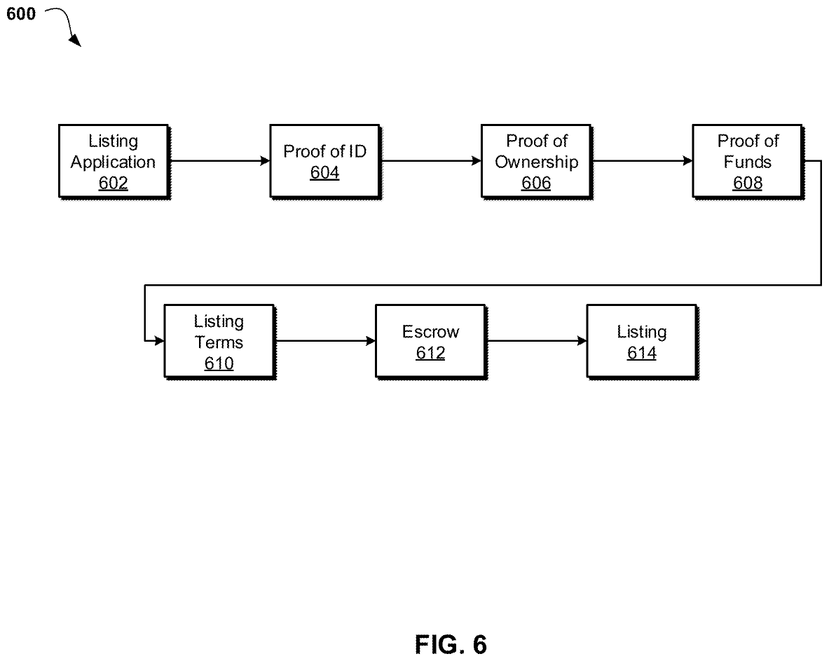

FIG. 6 illustrates a block diagram of an end-to-end listing process by an NFT ownership process according to at least one embodiment. At 602, an initial application form to list an NFT may be ingested via a smart contract on the ledger. Then, at 604, proof-of-ID may be provided in order to verify that the party or entity submitting the initial application form is authentic. Next, at 606, a bureau, such as bureau 508, or a title company, such as title 510, may be queried to certify ownership of an entity, such as entity 506, as well as any assets associated with the entity. Then, at 608, proof of funds may be submitted in order to certify an income stream, conduct an audit on the entity, and establish expectations/projections and deposit requirements. Next, at 610, listing terms may be defined so that future inventors (i.e., fraction purchasers) can make informed decisions when choosing to purchase fractions. The listing terms may show assets, income, projections, and business plans that may dictate a valuation of the entity, how many fractions to list for sale, and how investors can expect to make a return on investment. The listing terms may also contain items such as dividends and exit strategies in case the entity wishes to exit the marketplace (e.g., purchase back fractions and remove the f-NFT from the marketplace 518. Then, at 612, an escrow service may be utilized to hold deposits and place liens against entity ventures and assets in order to lock funds should figures provided in the proof-of-funds change in value. Next, at 614, the listing may be approved and fractions posted to the marketplace 518 to allow purchasers to invest in the entity through the purchase of fractions.

It may be appreciated that FIGS. 2-6 provide only an illustration of one implementation and do not imply any limitations with regard to how different embodiments may be implemented. Many modifications to the depicted environments may be made based on design and implementation requirements. Although a fractional NFT is described throughout, a non-fractional NFT may be utilized as the subject of the NFT ownership program 110A, 110B and the various described event including, but not limited to, the takeover event described in FIG. 3 and the fraction splitting event described in FIG. 4.

In at least one other embodiment, the described takeover event may be an aggressive takeover event. An aggressive takeover event may be defined in the parameters of the NFT as a offer by a purchaser that exceeds a threshold higher than that of a takeover event. For example, the takeover event threshold value may be 5% above the current average asking from for fractions of the NFT and the aggressive takeover event threshold value may be 100% above the current average asking from for fractions of the NFT. Under an aggressive takeover event, a buyer may outright purchase the NFT and have all fractions liquidated. According to at least one embodiment, the parameters established in the smart contract at the time of creation of the f-NFT may prohibit aggressive takeover events.

In at least one embodiment, the NFT ownership program 110A, 110B may also execute a reverse fraction splitting event similar to the fraction splitting event described in FIG. 4. A reverse fraction splitting event may be defined as a merging of fractions of the f-NFT in order to increase value. For example, a reverse fraction split may reduce the number of circulating fractions of the f-NFT in a 1-for-2 manner. When executing a fraction splitting event, the NFT ownership program 110A, 110B may only merge the fractions that are commonly owned by a single owner unless owners agree or opt-in to joint ownership of a newly merged fraction with other owners. For example, if Owner A and Owner B own individual fractions of an f-NFT and agree in a vote to merging and jointly owning their fractions as a single fraction, the NFT ownership program 110A, 110B may merge the fractions, list Owner A and Owner B as joint owners of the new fraction, and establish the value of the merged fraction as the sum of the values of the pre-merged fractions. Conversely, the NFT ownership program 110A, 110B may not merge the fractions of owners that do not agree in a vote to merge their fractions and hold ownership jointly. For example, if Owner C and Owner D each own a single fraction of an f-NFT, the NFT ownership program 110A, 110B may not merge their fractions if they vote to continue sole ownership of the separate fractions.

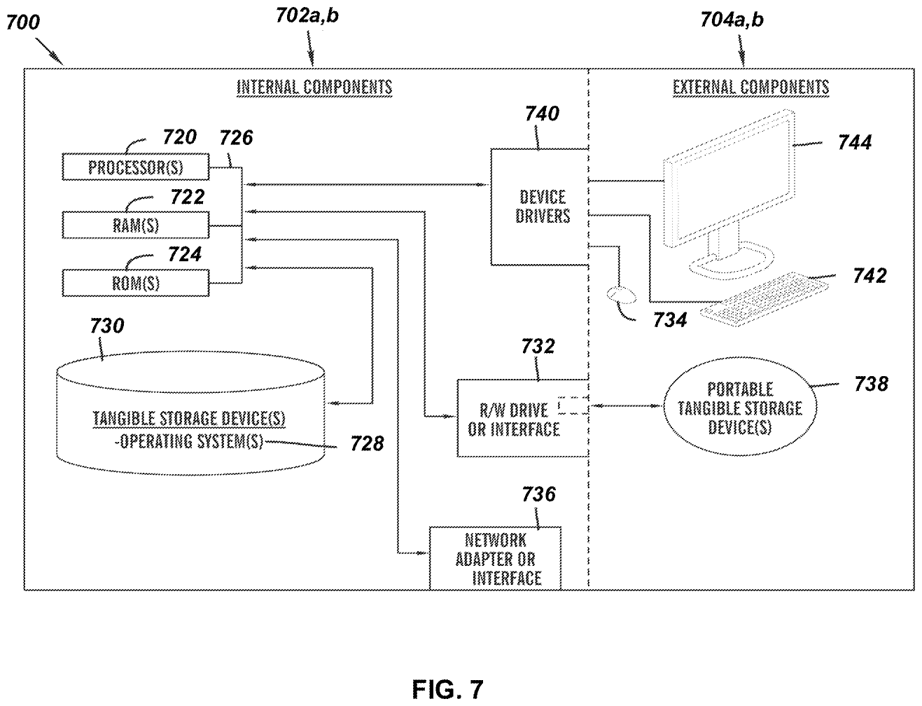

FIG. 7 is a block diagram 700 of internal and external components of the client computing device 102 and the server 112 depicted in FIG. 1 in accordance with an embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

The data processing system 702, 704 is representative of any electronic device capable of executing machine-readable program instructions. The data processing system 702, 704 may be representative of a smart phone, a computer system, PDA, or other electronic devices. Examples of computing systems, environments, and/or configurations that may represented by the data processing system 702, 704 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 702 a,b and external components 704 a,b illustrated in FIG. 7. Each of the sets of internal components 702 include one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 108 and the NFT ownership program 110A in the client computing device 102 and the NFT ownership program 110B in the server 112 are stored on one or more of the respective computer-readable tangible storage devices 730 for execution by one or more of the respective processors 720 via one or more of the respective RAMs 722 (which typically include cache memory). In the embodiment illustrated in FIG. 7, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 702 a,b also includes a RAY drive or interface 732 to read from and write to one or more portable computer-readable tangible storage devices 738 such as a CD-ROM, DVD, memory stick, magnetic tape, magnetic disk, optical disk or semiconductor storage device. A software program, such as the NFT ownership program 110A, 110B, can be stored on one or more of the respective portable computer-readable tangible storage devices 738, read via the respective R/W drive or interface 732, and loaded into the respective hard drive 730.

Each set of internal components 702 a,b also includes network adapters or interfaces 736 such as a TCP/IP adapter cards, wireless Wi-Fi interface cards, or 3G, 4G, or 5G wireless interface cards or other wired or wireless communication links. The software program 108 and the NFT ownership program 110A in the client computing device 102 and the NFT ownership program 110B in the server 112 can be downloaded to the client computing device 102 and the server 112 from an external computer via a network (for example, the Internet, a local area network or other, wide area network) and respective network adapters or interfaces 736. From the network adapters or interfaces 736, the software program 108 and the NFT ownership program 110A in the client computing device 102 and the NFT ownership program 110B in the server 112 are loaded into the respective hard drive 730. The network may comprise copper wires, optical fibers, wireless transmission, routers, firewalls, switches, gateway computers and/or edge servers.

Each of the sets of external components 704 a,b can include a computer display monitor 744, a keyboard 742, and a computer mouse 734. External components 704 a,b can also include touch screens, virtual keyboards, touch pads, pointing devices, and other human interface devices. Each of the sets of internal components 702 a,b also includes device drivers 740 to interface to computer display monitor 744, keyboard 742, and computer mouse 734. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

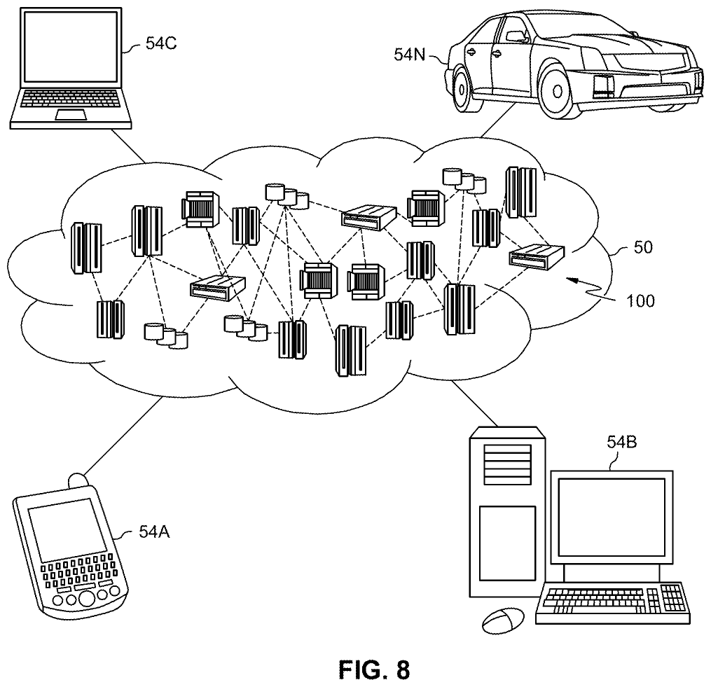

Referring now to FIG. 8, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 100 and cloud computing environment 50 can communicate with any type of computerized device over any type of network and/or network addressable connection (e.g., using a web browser).

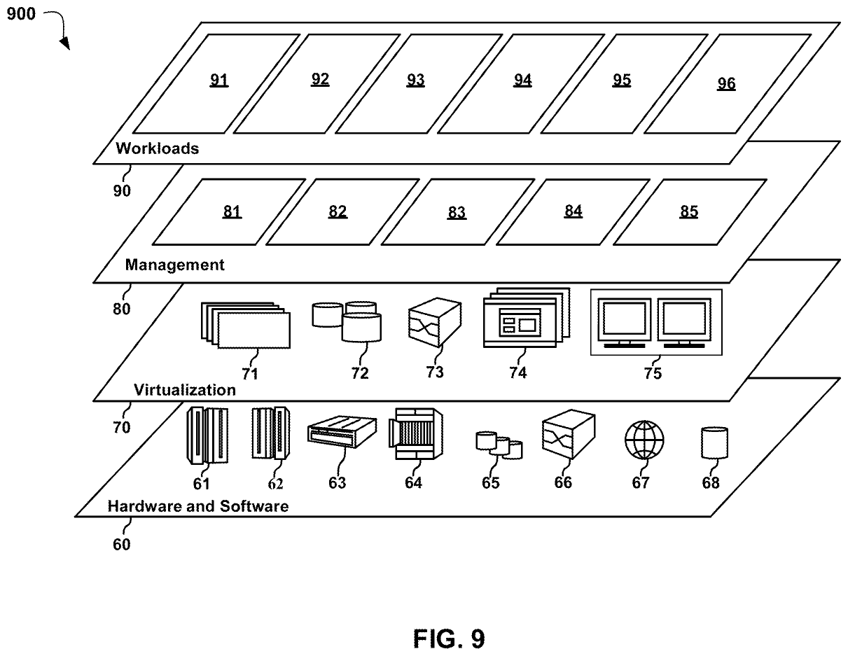

Referring now to FIG. 9, a set of functional abstraction layers 900 provided by cloud computing environment 50 is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and organization NFT trading 96. Organization NFT trading may relate to minting and trading of an NFT associated with an organization and executing various events associated with the NFT when preconfigured triggers are satisfied.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
minting a mark associated with an entity as a fractional non-fungible token by a creator with ownership or authority over the mark, wherein the creator establishes a plurality of parameters during the minting;
processing one or more purchases of one or more fractions of the fractional non-fungible token by one or more individuals from the creator;
monitoring data associated with the fractional non-fungible token for criteria that triggers an event; and
in response to the criteria being present, executing the event.

2. The method of claim 1, further comprising:
verifying the creator attempting to mint the mark owns or has authority to mint the mark.

3. The method of claim 1, wherein the entity is selected from a group consisting of an organization, a piece of real estate, and a tangible item.

4. The method of claim 1, wherein the event is a takeover event further comprising:
receiving an offer and a down payment in escrow from an offeree;
prompting each owner with an interest in any fraction of the fractional non-fungible token to vote as to whether to accept the offer;
in response to determining, based on the plurality of parameters, the offer is accepted:
executing a payment equal to a value of the down payment to each owner;
transferring ownership of each fraction of the fractional non-fungible token from each owner to the offeree, wherein the offeree becomes a sole owner of all fractions of the non-fungible token;
generating a non-fungible token from the fractional non-fungible token, wherein the generated non-fungible token assumes the plurality of parameters of the fractional non-fungible token; and
burning the fractional non-fungible token.

5. The method of claim 4, further comprising:
modifying the plurality of parameters associated with the generated non-fungible token based on selections made by the sole owner.

6. The method of claim 1, wherein the event is a fraction splitting event further comprises:
prompting each owner with an interest in any fraction of the fractional non-fungible token to vote as to whether to execute the fraction split; and
in response to determining, based on the plurality of parameters, to split each fraction of the fractional non-fungible token, executing the split based on the plurality of parameters.

7. The method of claim 1, wherein the event is selected from a group consisting of a takeover event, an aggressive takeover event, a fraction splitting event, and a reverse fraction splitting event.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
minting a mark associated with an entity as a fractional non-fungible token by a creator with ownership or authority over the mark, wherein the creator establishes a plurality of parameters during the minting;
processing one or more purchases of one or more fractions of the fractional non-fungible token by one or more individuals from the creator;
monitoring data associated with the fractional non-fungible token for criteria that triggers an event; and
in response to the criteria being present, executing the event.

9. The computer system of claim 8, further comprising:
verifying the creator attempting to mint the mark owns or has authority to mint the mark.

10. The computer system of claim 8, wherein the entity is selected from a group consisting of an organization, a piece of real estate, and a tangible item.

11. The computer system of claim 8, wherein the event is a takeover event further comprising:
receiving an offer and a down payment in escrow from an offeree;
prompting each owner with an interest in any fraction of the fractional non-fungible token to vote as to whether to accept the offer;
in response to determining, based on the plurality of parameters, the offer is accepted:
executing a payment equal to a value of the down payment to each owner;
transferring ownership of each fraction of the fractional non-fungible token from each owner to the offeree, wherein the offeree becomes a sole owner of all fractions of the non-fungible token;
generating a non-fungible token from the fractional non-fungible token, wherein the generated non-fungible token assumes the plurality of parameters of the fractional non-fungible token; and
burning the fractional non-fungible token.

12. The computer system of claim 11, further comprising:
modifying the plurality of parameters associated with the generated non-fungible token based on selections made by the sole owner.

13. The computer system of claim 8, wherein the event is a fraction splitting event further comprises:
prompting each owner with an interest in any fraction of the fractional non-fungible token to vote as to whether to execute the fraction split; and
in response to determining, based on the plurality of parameters, to split each fraction of the fractional non-fungible token, executing the split based on the plurality of parameters.

14. The computer system of claim 8, wherein the event is selected from a group consisting of a takeover event, an aggressive takeover event, a fraction splitting event, and a reverse fraction splitting event.

15. A computer program product, the computer program product comprising:
one or more computer-readable tangible storage medium and program instructions stored on at least one of the one or more tangible storage medium, the program instructions executable by a processor capable of performing a method, the method comprising:
minting a mark associated with an entity as a fractional non-fungible token by a creator with ownership or authority over the mark, wherein the creator establishes a plurality of parameters during the minting;
processing one or more purchases of one or more fractions of the fractional non-fungible token by one or more individuals from the creator;
monitoring data associated with the fractional non-fungible token for criteria that triggers an event; and
in response to the criteria being present, executing the event.

16. The computer program product of claim 15, further comprising:
verifying the creator attempting to mint the mark owns or has authority to mint the mark.

17. The computer program product of claim 15, wherein the entity is selected from a group consisting of an organization, a piece of real estate, and a tangible item.

18. The computer program product of claim 15, wherein the event is a takeover event further comprising:
receiving an offer and a down payment in escrow from an offeree;
prompting each owner with an interest in any fraction of the fractional non-fungible token to vote as to whether to accept the offer;
in response to determining, based on the plurality of parameters, the offer is accepted:
executing a payment in a value equal to the down payment to each owner;
transferring ownership of each fraction of the fractional non-fungible token from each owner to the offeree, wherein the offeree becomes a sole owner of all fractions of the non-fungible token;
generating a non-fungible token from the fractional non-fungible token, wherein the generated non-fungible token assumes the plurality of parameters of the fractional non-fungible token; and
burning the fractional non-fungible token.

19. The computer program product of claim 18, further comprising:
modifying the plurality of parameters associated with the generated non-fungible token based on selections made by the sole owner.

20. The computer program product of claim 15, wherein the event is a fraction splitting event further comprises:
prompting each owner with an interest in any fraction of the fractional non-fungible token to vote as to whether to execute the fraction split; and
in response to determining, based on the plurality of parameters, to split each fraction of the fractional non-fungible token, executing the split based on the plurality of parameters.
